(19) United States
(12) Patent Application Publication
(10) Pub. No.: US 2017/0265040 A1
(43) Pub. Date: Sep. 14, 2017

(54) VERIFICATION OF PICKUP TIMES IN REAL-TIME RIDE-SHARING FEEDS

(71) Applicant: GOOGLE INC., Mountain View, CA (US)

(72) Inventors: Anna Friedlander, Menzingen ZG (CH); Holger-Frederik Flier, Zurich ZH (CH)

(21) Appl. No.: 15/063,873

(22) Filed: Mar. 8, 2016

(51) Int. Cl. H04W 4/02; H04W 4/04

(52) U.S. Cl. CPC H04W 4/028; H04W 4/04

(57) ABSTRACT

In a method for determining accuracy of arrival time information, one or more ETAs are received from a transit service provider. Each ETA indicates a time at which the transit service provider purports to be able to provide a transit service at a respective location. An ETA corresponding to a target location of a mobile communications device is determined and sent to the mobile communications device for display to a user. User activity data indicative of locations of the mobile communications device over time is logged, and processed to determine both (i) that the user did use the transit service provider and (ii) the time at which the transit service was actually provided at the target location. A time difference between the ETA and the actual arrival time is then calculated.

### FIELD OF TECHNOLOGY

The present disclosure relates to real-time estimated time of arrival (ETA) feeds and, more particularly, to using data relating to user entries and movements associated with mobile communications devices to measure the accuracy of location-specific (e.g., point-specific or area-specific) ETAs provided in real-time feeds.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Increasingly, smartphone and other mobile communications device users are provided with real-time information to facilitate everyday tasks or needs. For example, individuals may use dedicated applications or web browsers to view updates to various types of schedules, such as train or bus arrival times at a particular stop. In some instances, such real-time information is provided via a mapping application. For example, smartphones with mapping applications may enable users to view estimated times of arrival (ETAs) for taxi, ride-sharing and/or other transit services.

Typically, real-time ETA feeds are sourced by the transit service providers, which presumably know the locations of fleet vehicles and therefore are in the best position to estimate arrival times at various pickup locations. Naturally, users/customers may be more inclined to choose transit service providers offering relatively low ETAs. Unfortunately, this can give rise to a “race to the bottom” scenario in which the transit service providers underestimate ETAs in order to remain competitive. For the user/customer, this state of affairs could result in frustration and/or scheduling difficulties, with transit services often arriving later than estimated.

### SUMMARY

To measure the accuracy of estimated times of arrival (ETAs) from a transit service provider (e.g., taxi, ride-sharing, train, bus or other transit service company or agency, etc.), a system processes user activity data (e.g., movement data generated by a GPS system on a user's smartphone) and/or user entry data (e.g., data indicative of inputs made by a user on his or her smartphone, such as selecting a particular transit service provider) to determine whether a user used the transit service provider to get to a desired destination. If it is determined that the user did use the transit service provider, the real-time ETA that was initially presented to the user may be compared with the actual time of arrival. The actual time of arrival may also be determined by processing user activity data (e.g., by determining when the user changed from a walking or standing state to riding in a vehicle). The comparison of the estimated and actual times of arrival—either alone or in combination with a number of other similar comparisons involving the same transit service provider—may be used to calculate one or more accuracy metrics for the transit service provider. The accuracy metric(s) may then be sent to the transit service provider to encourage the transit service provider to improve or maintain ETA accuracy, to allow the transit service provider to compare its performance between different geographic locations, and/or for other purposes. Alternatively, or additionally, the accuracy metric(s) may be used to filter, rank and/or rate transit service providers when presenting transit options to future users.

In one example embodiment, a method, implemented in one or more servers, for determining accuracy of arrival time information provided by a first transit service provider includes receiving, from the first transit service provider, one or more ETAs. Each of the one or more ETAs indicates a time at which the first transit service provider purports to be able to provide a transit service at a respective location (e.g., a particular point, a particular stop or station, or a particular region/area). The method also includes determining, by one or more processors of the one or more servers and based on at least one of the one or more ETAs, a first ETA corresponding to a target (e.g., pickup) location. The method also includes sending the first ETA to the mobile communications device for display to a user via a user interface of the mobile communications device, and logging, by the one or more processors, user activity data indicative of locations of the mobile communications device over time (e.g., data from which user movement can be inferred or calculated). The method also includes determining, by the one or more processors and based on the logged user activity data, (i) that the user used the transit service provided by the first transit service provider, and (ii) a time at which the transit service was provided at the target location. The method also includes calculating, by the one or more processors, a time difference between the first ETA and the time at which the transit service was provided at the target location.

In another example embodiment, a system for determining accuracy of arrival time information includes a network interface, and one or more databases collectively storing (i) user activity data indicative of locations of mobile communications devices over time and (ii) user entry data indicative of inputs made by users via user interfaces of the mobile communications devices (e.g., data indicative of selections of particular transit service providers). The system also includes one or more servers collectively configured to receive, from a first transit service provider via the network interface, one or more ETAs. Each of the one or more ETAs indicates a time at which the first transit service provider purports to be able to provide a transit service at a respective location. The one or more servers are also collectively configured to determine, based on at least one of the one or more ETAs, a first ETA corresponding to a target (e.g., pickup) location, send, via the network interface, the first ETA to the first mobile communications device for display to a first user via a user interface of the first mobile communications device, and to log, in the one or more databases, (i) first user activity data indicative of locations of the first mobile communications device over time and (ii) first user entry data indicative of inputs made by the first user via the user interface of the first mobile communications device. The one or more servers are also collectively configured to determine, based on the logged first user activity data and the logged first user entry data, that the user used the transit service provided by the first transit service provider, to determine, based on the logged user activity data, a time at which the transit service was provided at the target location, and to calculate a time difference between the first ETA and the time at which the transit service was provided at the target location.

In yet another example embodiment, a method for displaying arrival time information with indicia of ETA reliability is implemented in a mobile communications device having a user interface, a network interface and one or more processors. The method includes receiving a destination from a user via the user interface, transmitting the destination to one or more remote servers via the network interface, and receiving from the one or more remote servers, via the network interface, transit option data indicative of (i) a plurality of transit services (e.g., names of different providers of the transit services, names of different transit services offered by a single provider, etc.), and (ii) a plurality of ETAs each corresponding to a target (e.g., pickup) location and a respective one of the plurality of transit services. The method also includes displaying a plurality of transit options to the user via the user interface. Each of the plurality of transit options corresponds to a respective one of the plurality of transit services and includes the respective one of the plurality of ETAs. One or both of: (i) the transit option data is further indicative of relative reliability levels for the plurality of ETAs (e.g., by specifying an ordered sequence of the providers/ETAs that corresponds to a set of rankings), and displaying the plurality of transit options includes displaying the plurality of transit options according to the relative reliability levels (e.g., in the ordered sequence), and (ii) the transit option data is further indicative of a plurality of reliability ratings each corresponding to a respective one of the plurality of ETAs, and displaying the plurality of transit options further includes displaying the plurality of reliability ratings.

### BRIEF DESCRIPTION OF THE DRAWINGS

FIG. 1 is a block diagram of an example system in which techniques for determining the accuracy of estimated times of arrival (ETAs) for transit services and/or transit service providers may be implemented.

FIG. 2 depicts an example interactive display provided by a mapping application.

FIG. 3 depicts an example collection of segmented user activity data that may be used to determine accuracy of one or more ETAs.

FIG. 4 is a map-based representation of the segmented user activity data shown in FIG. 3.

FIG. 5 is a flow diagram of an example method for determining accuracy of arrival time information provided by a transit service provider.

FIG. 6 is a flow diagram of another example method for determining accuracy of arrival time information provided by a transit service provider.

FIG. 7 depicts an example collection of ETA accuracy data that may be used to calculate metrics indicative of overall ETA accuracy for transit services.

FIG. 8 is a flow diagram of an example method for displaying arrival time information with indicia of ETA reliability.

### DETAILED DESCRIPTION OF THE DRAWINGS

### Overview

In some implementations of the invention disclosed herein, a mapping service provides mobile communications device users (e.g., smartphone users, tablet users, etc.) with estimated times of arrival (ETAs) from one or more transit service providers (e.g., taxi or ride-share providers such as Uber, Easy Taxi, or bus or train service providers, etc.) based on target/pickup locations. For example, a user may launch a mapping application on his or her mobile device and enter directions from his or her current location (or a nearby location) to a particular destination, and then be presented with a number of options corresponding to different transit services and/or transit service providers (e.g., transit services from different taxi companies, and/or different transit services from a single provider such as UberX and UberBLACK, etc.). Each option/provider may be associated with an ETA that the map server obtained from the respective transit service provider via a real-time feed, or an ETA that was calculated based on a number of ETAs from such a feed. Each ETA represents the purported time it will take for a vehicle of the transit service to arrive at the pickup location if the ride were to be booked/requested immediately. For privacy reasons, ETAs may be obtained from the transit service providers without sending any user location information to the transit service providers. For example, the real-time feed for a given transit service provider may include a “heat map” of ETAs associated with different areas, and the map server may select the appropriate ETA from the heat map (or interpolate an ETA based on the heat map information, etc.) based on the pickup location.

Users will generally be more attracted to transit service offering relatively low ETAs. This fact, combined with the fear of competitors providing unrealistically low ETAs, may motivate transit service providers to underestimate or falsify their own ETAs. To prevent this “race to the bottom” scenario, it would be beneficial to determine the accuracy of the ETAs from transit service providers. To measure ETA accuracy, the ETAs in real-time feeds may be compared to “actual” arrival/pickup times. Initially, this process may include determining which transit service, if any, was selected by a user. If a user “clicks” on a link to a particular transit service, for example, and if the user has consented to the collection and use of such data, then that transit service may be tagged (e.g., during later batch processing) as a service that the user potentially used to reach his or her desired destination.

Various techniques may be used to confirm that a tagged transit service was actually used. For instance, if a user consents to the collection and use of such data, user activity data relating to the user's location(s) and movements may be processed to identify various timeline “segments.” Each segment may correspond to a time period during which the user's movements suggest that he or she was performing a particular type of movement-related activity, such as walking, standing, or riding in a vehicle. Based on the user's location, and the timing of the user changing from a standing or walking segment to a vehicle riding segment, it may be inferred that a user did indeed use a selected transit service. With the user's consent, other data may also be used to infer or confirm that the transit service was used. If the user entered a destination in a mapping application prior to being presented with the provider/ETA results, for example, that destination may be compared with the user's actual destination (e.g., at the end of the vehicle riding segment) to determine whether the transit service was used.

If it can be inferred that a particular transit service was used, the ETA that was presented to the user just prior to his or her selection of the transit service (or just prior to his or her booking a ride with the transit service, etc.) may be compared with an actual arrival time. The actual arrival time may be the time of the start of the ride as detected from the user activity data (e.g., using the “segments” described above). Based on the comparison of estimated and actual arrival times, and based on other similar comparisons made in connection with other users and the same transit service or transit service provider, one or more ETA accuracy metrics may be calculated. The accuracy metric(s) may be used in various different ways to ensure that transit service providers do not frequently and/or intentionally underestimate their ETAs. For example, accuracy metric(s) may be sent to transit service providers as feedback in an effort to get the transit service providers to improve ETA accuracy, or to allow the transit service providers to compare ETA accuracy performance between different geographic locations and/or different transit services. As another example, the metrics may be used to rank/order different transit services when a future user is presented with a set of transit service options within a mapping or other application.

Other implementations and/or uses of the invention are also possible. For example, variations of the above techniques may be used to measure or verify delays in public transportation (buses, trains, etc.) reported by a transit agency or third party data provider.

### Example System

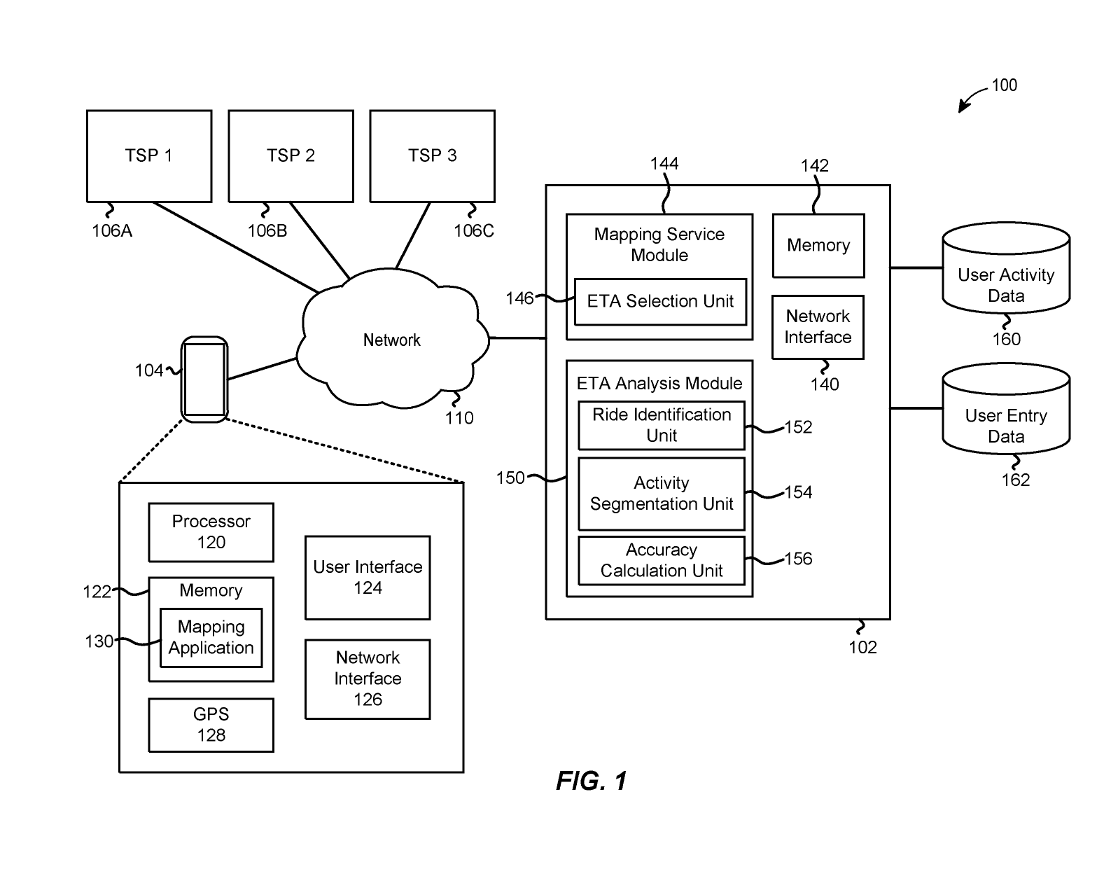

FIG. 1 illustrates an example system 100 in which techniques for determining the accuracy of estimated times of arrival (ETAs) for transit services and/or transit service providers may be implemented. The system 100 includes a map server 102, a mobile communications device 104, and transit service providers 106A-106C. In various different implementations and/or scenarios, transit service providers 106A-106C may all be providers of a single type of transit service (e.g., taxi service, ride-sharing service, bus service, train service, etc.), or may include providers of different, related types of transit services (e.g., a combination of taxi and ride-sharing services). Moreover, in some implementations and/or scenarios, one or more of transit service providers 106A-106C may offer multiple types of transit services (e.g., UberX and UberBLACK).

While FIG. 1 shows only three transit service providers 106A-106C, it is understood that the system 100 may include more or fewer than three transit service providers. In some implementations or scenarios where transit service providers are train or bus service providers, for example, there may be only a single transit service provider 106A. Moreover, as will be apparent from the context of usage, references herein to the transit service providers 106A-106C may refer to the providers themselves (e.g., the companies or other entities providing transit services), or may refer to computing devices or computing systems associated with (e.g., owned or maintained by) those providers. For example, it is understood that any electronic communications described herein as being between one of “transit service providers 106A-106C” and map server 102 refer to communications between computing devices or systems of the transit service provider (e.g., a client device, server, etc.) and map server 102. Similarly, it is understood that any references to the physical locations of “transit service providers 106A-106C” (e.g., “remote” from one or more other components of system 100) refer to the locations of the computing devices or systems of the transit service providers.

Map server 102 is remote from mobile communications device 104 and transit service providers 106A-106C, and communicatively coupled to the mobile communications device 104 and transit service providers 106A-106C via a network 110. Network 110 may include any suitable combination of wired and/or wireless communication networks, such as one or more local area networks (LANs), metropolitan area networks (MANs), and/or wide area network (WANs). As just one specific example, network 110 may include a cellular network, the Internet, and a server-side LAN. In some implementations, the portion(s) of network 110 used by mobile communications device 104 to communicate with map server 102 may be wholly or partially separate from and independent of the portion(s) of network 110 that is/are used by transit service providers 106A-106C to communicate with map server 110.

While referred to herein as a “server,” map server 102 may, in some implementations, include multiple servers and/or other computing devices. For example, map server 102 may consist of a single server providing both a mapping service and other functionality related to determining ETA accuracy (as discussed in further detail below), or may include a first server for providing a mapping service and a second server or other computing device configured to determine ETA accuracy.

Mobile communications device 104 may be any mobile computing device with wireless communication capability (e.g., a smartphone, tablet computer, laptop computer, smart glasses, vehicle head unit computer, or other mobile or portable computing device). While FIG. 1 shows only a single mobile communications device 104, it is understood that map server 102 may also be in communication with numerous other mobile communications devices similar to mobile communications device 104. In the example implementation of FIG. 1, mobile communications device 104 includes a processor 120, a memory 122, a user interface 124, a network interface 126, and a global positioning system (GPS) unit 128. The processor 120 may be a single processor (e.g., a central processing unit (CPU)), or may include a set of processors (e.g., a CPU and a graphics processing unit (GPU)).

Memory 122 is a computer-readable, non-transitory storage unit or device, or collection of units/devices, that may include persistent (e.g., hard disk) and/or non-persistent memory components. Memory 122 stores instructions that are executable on processor 120 to perform various operations, including the instructions of various software applications and data generated and/or used by such applications. In the example implementation of FIG. 1, memory 122 stores at least a mapping application 130. Generally, mapping application 130 is executed by processor 120 to access the mapping services provided by map server 102 (e.g., displaying current location to a user, accepting user inputs relating to panning, zooming or entering directions, displaying directions in response to a user navigation request, etc.). While the description below refers to a mapping “application,” it is understood that, in other implementations, other arrangements may be used to access the mapping services provided by map server 120. For example, mobile communications device 104 may instead access the mapping services via a web browser provided by a web browser application stored in memory 122.

User interface 124 includes hardware, firmware and/or software configured to enable a user to interact with (i.e., both provide inputs to and perceive outputs of) the mobile communications device 104. For example, user interface 124 may include a touchscreen with both display and manual input capabilities. Alternatively, or in addition, user interface 124 may include a keyboard for accepting user inputs, and/or a microphone (with associated processing components) that provides voice control/input capabilities to the user.

Network interface 126 includes hardware, firmware and/or software configured to enable mobile communications device 104 to wirelessly exchange electronic data with map server 102 via network 110. For example, network interface 126 may include a cellular communication transceiver, a WiFi transceiver, and/or transceivers for one or more other wireless communication technologies. The GPS unit 128 includes hardware, firmware and/or software configured to enable mobile communications device 104 to self-locate using GPS technology (alone, or in combination with the services of map server 102 and/or another server not shown in FIG. 1). Alternatively, or in addition, mobile communications device 104 may include a unit configured to self-locate, or configured to cooperate with a remote server or other device(s) to self-locate, using other, non-GPS technologies. For example, mobile communications device 104 may include a unit configured to self-locate using WiFi positioning technology (e.g., by sending signal strengths detected from nearby access points to map server 102, or to another server able to retrieve access point locations from a database).

Map server 102 includes a network interface 140, a memory 142, a mapping service module 144 and an ETA analysis module 150. The network interface 140 includes hardware, firmware and/or software configured to enable map server 102 to exchange electronic data with mobile communications device 104 and transit service providers 106A-106C via network 110. For example, network interface 140 may include a wired or wireless router and a modem.

Memory 142 is a computer-readable, non-transitory storage unit or device, or collection of units/devices, that may include persistent (e.g., hard disk) and/or non-persistent memory components. Memory 142 may store data generated and/or used by mapping service module 144 and/or ETA analysis module 150, and/or ETA data received from transit service providers 106A-106C, for example.

Mapping service module 144 is generally configured to provide mapping services to clients devices, such as mobile communications device 104. For example, mapping service module 144 may receive location information from client devices (e.g., current locations of the client devices, and/or information representing addresses or other locations entered by users at the client devices, etc.), and in response provide the client devices with respective sets of map data to be rendered or otherwise displayed at the client devices. As another example, mapping service module 144 may receive requests for directions from client devices, and in response provide the client devices with respective sets of text and/or map-based directions to the desired destinations. Mapping service module 144 also includes an ETA selection unit 146, described further below.

ETA analysis module 150 is generally configured to perform various operations that enable map server 102 to determine the accuracy of ETAs provided by various transit service providers, such as transit service providers 106A-106C. ETA analysis module 150 includes a ride identification unit 152, an activity segmentation unit 154, and an accuracy calculation unit 156, each of which will be described further below.

In some implementations, mapping service module 144 and/or ETA analysis module 150 may be (or may include) respective sets of one or more processors that execute software instructions stored in memory 142 (or elsewhere) to perform the functions described herein, or may share a set of one or more processors. Alternatively, mapping service module 144 and/or ETA analysis module 150 may be components of software stored in memory 142 (or elsewhere) and executed by one or more processors (not shown in FIG. 1) of map server 102 to perform the functions described herein. In some implementations, map server 102 may include more, fewer and/or different modules or units than are shown in FIG. 1.

Generally, if a user has explicitly agreed to share his or her information with map server 102, map server 102 may collect from a mobile communications device user activity data relating to movement (e.g., locations of the devices over time), and user entry data relating to entries made by the users of the mobile communications devices via user interfaces (e.g., touchscreen taps or swipes, keyboard entries, etc.). Map server 102 may log the user activity data in a user activity database 160, and log the user entry data in a user entry database 162. Each of databases 160 and 162 may be stored in a single memory, or may be distributed across multiple memories and/or locations. Further, databases 160 and 162 may be separate, or the information within databases 160 and 162 may be included within a single database. As just one example, the user activity data may include, for each of multiple devices/users, a series of precise locations (e.g., latitude/longitude coordinates) each with a corresponding time stamp representing the time at which the device was at that precise location. As another example, the user entry data may include, for each of the devices/users, a series of inputs made by the user via a user interface of the device, each with a corresponding time stamp representing the time at which the input was made.

In operation, according to one example implementation, each of transit service providers 106A-106C provides a real-time feed of ETAs to map server 102 via network 110 and network interface 140. If one of transit service providers 106A-106C provides multiple transit services, that provider may provide a separate real-time ETA feed for each transit service, or may provide a single real-time feed in which each ETA corresponds to a service type indicator. Each ETA specifies the amount of time, according to the transit service provider sourcing the ETA, that it will take for the transit service provider to provide a transit service at a particular location (e.g., based on the current location of the nearest available vehicle/driver/fleet member of the transit service provider, or the current location of the nearest train or bus, etc.). The ETAs may be expected times of arrival, or expected “worst case” (maximum) times of arrival, for example. Moreover, the ETAs may be expressed as relative times (i.e., relative to the current time, such as “5 minutes”) or absolute times (e.g., “3:53 PM,” “15:16 GMT,” “7:12 EST,” etc.).

The real-time ETAs from transit service providers 106A-106C may be pushed or pulled to map server 102 via any suitable method. As just one example, transit service providers 106A-106C may include respective client computing devices and use HTTP post operations to send the real-time ETAs to map server 102. The ETAs may be provided periodically (e.g., once every 15 seconds, once a minute, etc.), or on another suitable basis (e.g., in response to requests from map server 102).

The transit service providers 106A-106C may also provide the ETAs in various different formats. For example, each of transit service providers 106A-106C may periodically send map server 102 a table of ETAs each associated with a particular location (e.g., a particular latitude/longitude). As another example, each of transit service providers 106A-106C may periodically send map server 102 data representing a “heat map,” where each ETA is associated with a respective cell or other two-dimensional geographic area for which the ETA is purported to be valid. In still other implementations, transit service providers 106A-106C send map server 102 real-time ETAs only for specific locations (e.g., specific points or areas) indicated by map server 102. To better protect user privacy, however, it is preferred that map server 102 does not send any location information to any of transit service providers 106A-106C.

Within map server 102, ETA selection unit 146 selects the ETAs that best correspond to a particular “target” location. The target location may be the current location of mobile communications device 104. For example, mobile communications device 104 may have determined using GPS unit 128 before sending that location to map server 102, or map server 102 may have helped to locate mobile communications device 104 (and therefore may already know the current location). Alternatively, the target location may be a location that the user of mobile communications device 104 entered as a starting point when requesting directions from map server 102 via mapping application 130. Other possibilities also exist. In implementations or scenarios where system 100 includes only a single transit service provider 106A such as a train (e.g., a long-distance passenger train or a subway train) or bus service, for example, the target location may be a station that is nearest to the current location of mobile communications device 104.

Once the target location is known to map server 102, ETA selection unit 146 may select, for each of the transit services offered by transit service providers 106A-106C, the ETA corresponding to a location that is nearest the target location. In some implementations and/or scenarios, ETA selection unit may select, for each transit service, two or three (or more) ETAs that are nearest the target location, and use them to interpolate a more precise ETA for the target location. Even in such an implementation, of course, the accuracy of the resulting ETA will depend upon the accuracy of the ETAs from the transit service providers 106A-106C. Whether ETA selection unit 146 selects a single ETA that best corresponds to the target location, or uses two or more ETAs to calculate an ETA that corresponds to the target location, mapping service module 144 sends the resulting ETAs for transit service providers 106A-106C to mobile communications device 104, which may then present the ETAs to the user via user interface 124.

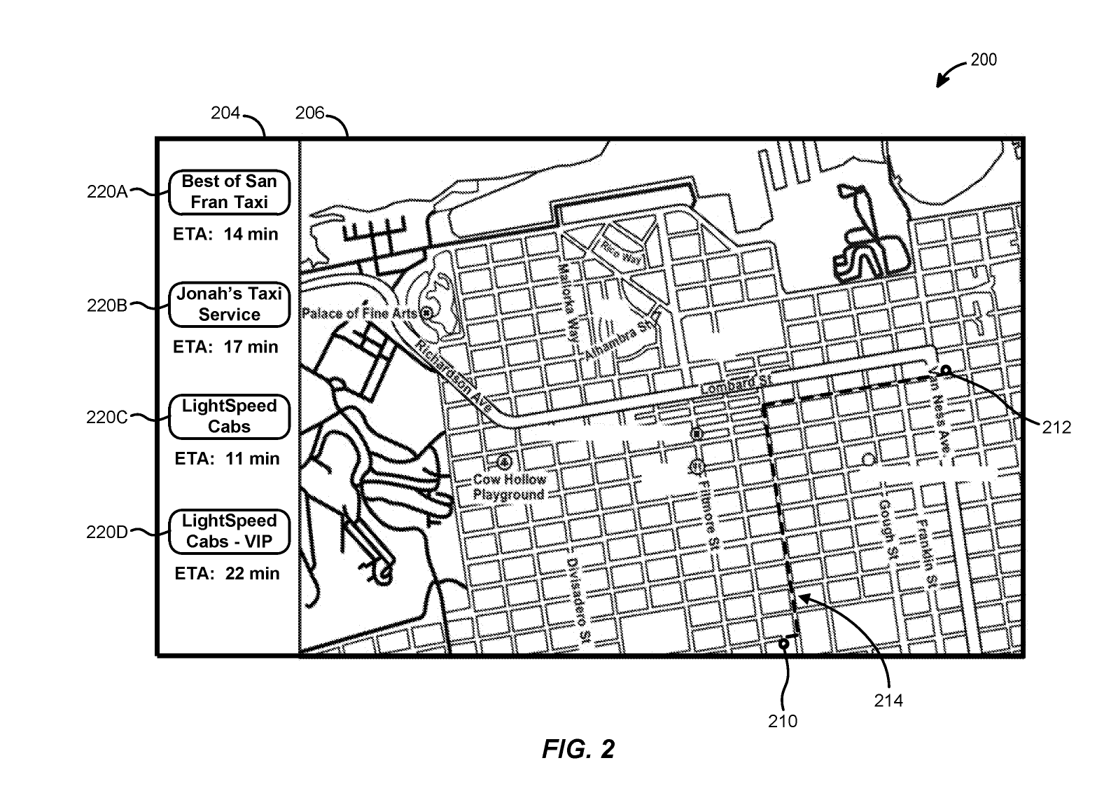

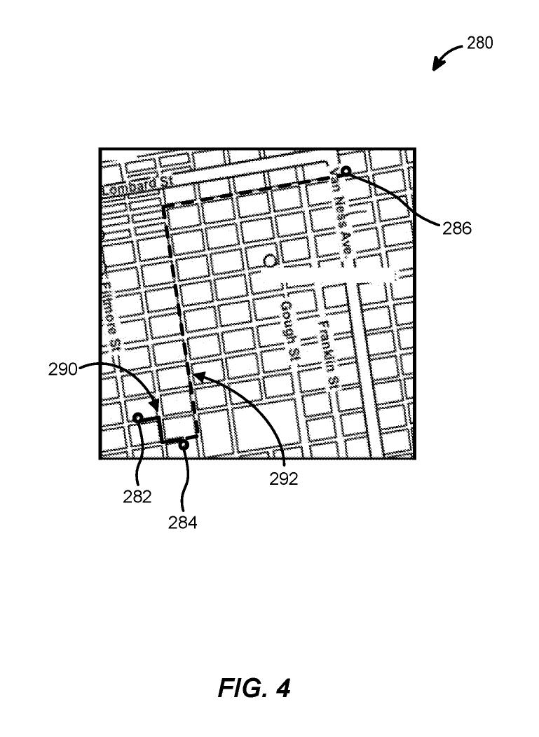

An example interactive display 200 that may be presented to the user via user interface 124 is shown in FIG. 2. Interactive display 200 may be a touchscreen display, for example, or a standard display on which a user may move a pointer via a touchpad, etc. In this example implementation, the interactive display 200 includes a transit portion 204 arranged to present transit service provider information to the user, and a map portion 206 arranged to present map and route information to the user. FIG. 4 represents a scenario in which the user has utilized the mapping application 130 to request directions from a target location 210 (e.g., his or her current location, or a starting location that the user entered when requesting directions) to a destination 212, and the map server 102 has responded with directions corresponding to a route 214. As seen in FIG. 2, the map portion 206 may display the target location 210, destination 212 and route 214 superimposed upon a map of the surrounding area.

The transit portion 204 displays the names of various transit services offered by transit service providers 106A-106C of FIG. 1, each along with the ETA that was selected or calculated for that transit service by ETA selection unit 146 as described above. In the example scenario of FIG. 2, transit service providers 106A and 106B each offer a single transit service, while transit service provider 106C offers two transit services (“LightSpeed Cabs” and “LightSpeed Cabs—VIP”). Other implementations may display the information shown in FIG. 2 in other ways, and/or display different types of information (e.g., a bus or train number superimposed on the map at a location near a station). In some implementations, interactive display 200 does not include transit portion 204, and all information is superimposed upon the map (or provided in a pop-up window, etc.).

Each of the transit service providers 106A-106C may be associated with a respective one of interactive controls 220A-220D (e.g., touchscreen buttons, etc.) that is also displayed within the transit portion 204. The user of mobile communications device 104 may select the desired transit service by activating the corresponding one of interactive controls 220A-220D. For example, a user wanting to choose “Best of San Fran Taxi” may activate the control 220A. Once the user has activated one of interactive controls 220A-220D, mobile communications device 104 may be connected to an on-line service or application (not shown in FIG. 1) associated with the corresponding one of transit service providers 106A-106C to allow the user to book/arrange the service. The booking services/applications may be hosted by servers of the respective transit service providers 106A-106C, for example. Alternatively, users may book/arrange transit services via functionality provided by map server 102. In some implementations and/or scenarios where transit service providers 106A-106C provide services such as train or bus services, the interactive display 200 may not include any controls such as controls 220A-220D, as there may be no need to book or otherwise pre-arrange a ride.

If the user has consented, map server 102 may log data indicative of the user's selection of one of interactive controls 220A-220D in user entry database 162, and log user activity data for mobile communications device 104 in user activity database 160. ETA analysis module 150 may then access the databases 160 and 162 at a later time (e.g., during once-a-day batch processing) to determine which transit service(s), if any, was/were selected, and to determine the accuracy of the ETA(s) for any such transit services.

To determine which transit services were used, ride identification unit 152 may process user entry data in database 162 and identify which transit services were selected. For example, ride identification unit 152 may determine that the user of mobile communications device 104 had selected “Best of San Fran Taxi” by activating control 220A. Of course, the mere activation of interactive control 220A does not necessarily mean that the user actually requested and/or used that transit service. For instance, the user may have activated interactive control 220A, only to decide against calling for a taxi or other transit service after having been transferred to a website or application associated with transit service provider 106A.

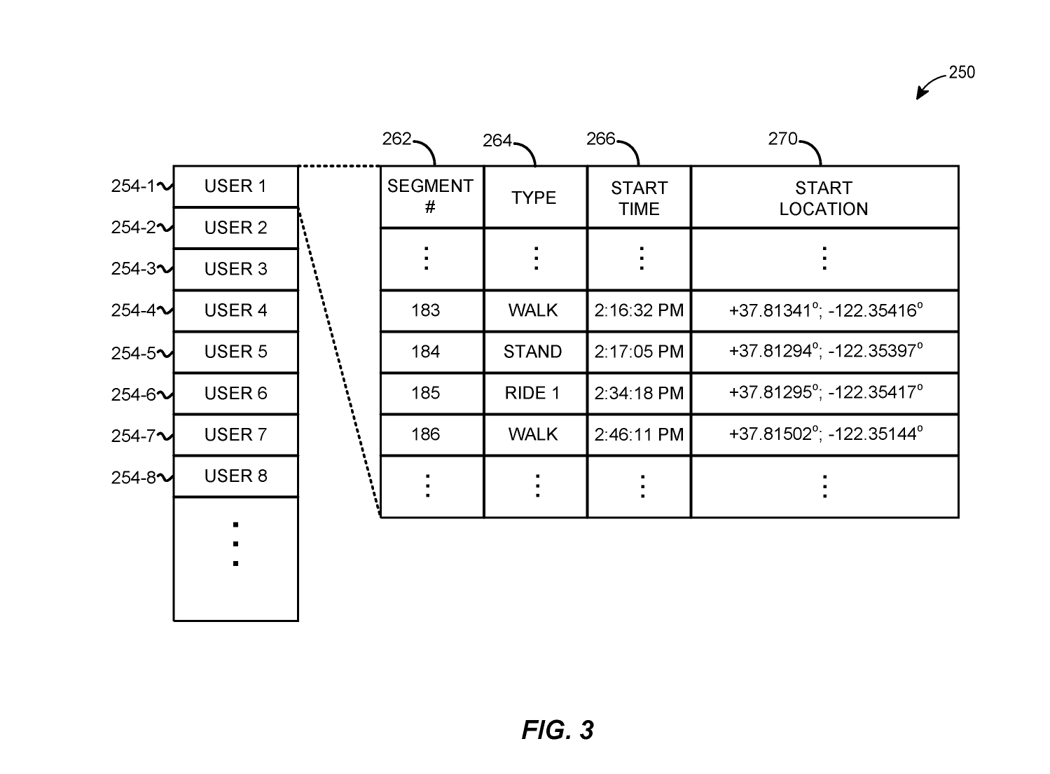

In some implementations, however, map server 102 may not receive any information from transit service provider 106A indicating whether the user actually booked a ride. Thus, ETA analysis module 150 may need to utilize other techniques to determine whether “Best of San Fran Taxi” did indeed provide transit for the user of mobile communications device 104. To this end, activity segmentation unit 154 may process time/location data of mobile communications device 104 logged in user activity database 160, and identify the types of movement-related activity in which the user was likely engaged during different time segments. For example, activity segmentation unit 154 may determine that the user was walking during a particular time segment if the time/location data indicates that the mobile communications device 104 was moving at less than 4 miles per hour during that time segment. As another example, activity segmentation unit 154 may determine that the user was standing during a particular time segment if the time/location data indicates that the mobile communications device 104 was moving at less than 0.1 miles per hour (and/or moved a total of less than 20 feet, etc.), or not moving at all, during that time segment. As yet another example, activity segmentation unit 154 may determine that the user was riding in a vehicle during a particular time segment if the time/location data indicates that the mobile communications device 104 was moving at, on average, more than 15 miles per hour (and/or had peak velocity of at least 25 miles per hour, etc.) during that time segment. When assigning a classifier/type to a particular time segment, activity segmentation unit 154 may select from among a pre-determined set of segment types (e.g., “standing,” “walking,” “running,” “biking,” “riding vehicle—automobile,” “riding vehicle—bus,” “riding vehicle—subway,” etc.). It is understood that the above classifications and criteria are merely illustrative, and that any other suitable criteria and/or categories/classifications may be used instead. Moreover, while not shown in FIG. 3, the data collection 250 may also include, for each segment identifier 262, a set of locations defining the route (if any) that was taken during that segment, and the times at which the user was at each of those locations.

FIG. 3 illustrates an example collection 250 of segmented user activity data. The data collection 250 may represent data output by activity segmentation unit 154 and logged in user activity database 160, for example. The example data collection 250 includes a number of user records 254 each corresponding to a different mobile communications device and/or device user. While many other arrangements and/or types of data may be used instead, the example data collection 250 includes, for each user, a number of segment identifiers 262, segment types 264, start times 266, and start locations 270. Each of segment types 264 may be set to the classification made by activity segmentation unit 154, with start time 266 indicating the starting time for that segment and start location 270 indicating the starting location for that segment. In other implementations (e.g., if the segments are not necessarily all contiguous in time and/or may fail to cover all time periods), each segment may also be associated with additional information, such as an “end time,” “end location,” etc.

In the scenario corresponding to FIG. 3, record 254-1 corresponds to mobile communications device 104, at a time after activity segmentation unit 154 has determined that the user of mobile communications device 104 (“User 1”) was walking, standing, riding, and then walking again during consecutive time segments. The segment type “Ride 1” may specifically indicate riding in an automobile, for example, whereas other designations (e.g., “Ride 2”) may indicate riding in a train, subway, etc. Activity segmentation module 154 use various other factors (e.g., lack of sudden changes in direction, etc.) to determine which type of vehicle was ridden. In some implementations, the functionality of activity segmentation module 154 is instead included in mobile communications device 104, which can then segment user activity data prior to sending that data to map server 102.

FIG. 4 is a map-based representation 280 of the segmented user activity data shown in FIG. 3. In particular, location 282 of the representation 280 corresponds to the “Start Location” of segment number 183 of FIG. 3, location 284 of the representation 280 corresponds to the “Start Location” of segment number 184 and/or segment number 185 of FIG. 3, and location 286 of the representation 280 corresponds to the “Start Location” of segment number 186 of FIG. 3. Moreover, route 290 corresponds to the route taken between the “Start Location” of segment numbers 183 and 184 of FIG. 3, and route 292 corresponds to the route taken between the “Start Location” of segment numbers 185 and 186 of FIG. 3. It is noted that the representation 280 is provided here merely for illustrative purposes, and is not necessarily generated, displayed or stored by any components of the system 100.

In some implementations, activity segmentation unit 154 segments user activity data for all users who have agreed to provide such data, regardless of whether the users have selected a transit service. In other implementations, activity segmentation unit 154 only segments user activity data for a particular user after ride identification unit 152 (or a different unit or module of map server 102) has determined that the user selected a particular transit service (e.g., via a control similar to one of interactive controls 220A-220D), and only for a relatively small time interval after the time of the user's selection (e.g., until the user arrives at the destination).

Returning now to the operation of the components in the system 100 of FIG. 1, ride identification unit 152 may, in response to determining that the user of mobile communications device 104 selected/activated the control 220A, process the data output by activity segmentation unit 154 to determine whether the user's activities (after selecting control 220A) were consistent with having used the transit service (“Best of San Fran Taxi”) provided by transit service provider 106A. This determination may take one or more factors into account. For example, if the user had entered a destination using mapping application 130 (e.g., destination 212 of FIG. 2), ride identification unit 152 may process the segmented user activity data to determine whether the user/device arrived at that destination. For instance, ride identification unit 152 may determine that a location of the user (e.g., location 286 of FIG. 4) matches, within a predetermined or dynamic distance tolerance and within a predetermined or dynamic time limit following the selection of control 220A, destination 212 of FIG. 2. Ride identification unit 152 may calculate the time limit based on the distance between the target/pickup location (e.g., location 210 of FIG. 2) and the destination (e.g., destination 212 of FIG. 2), for example.

Additionally, or alternatively, ride identification unit 152 may process the segmented user activity data to determine whether the user/device changed from a walking or standing segment to a vehicle riding segment at or near (e.g., within a predetermined or dynamic distance tolerance of) the target location (e.g., location 210 of FIG. 2). In other implementations, other factors may also, or instead, be used. For example, ride identification unit 152 may process the segmented user activity data to determine whether the user/device changed back from a vehicle riding segment to a walking or standing segment at or near (e.g., within a predetermined or dynamic distance tolerance of) destination 212 of FIG. 2. As another example, map server 102 may provide ride identification unit 152 with the best/fastest transit routes for a particular directions query, and ride identification unit 152 may process the segmented user activity data and the best route information to determine whether one or more recommended connections between different transit lines (e.g., bus or train lines) was/were used.

In implementations where ride identification unit 152 utilizes multiple factors to determine or confirm that a particular transit service was used, various algorithms may be used. For example, ride identification unit 152 may calculate a confidence score between 0 and 100 indicating a likelihood that the transit service was used, or require that some minimum number of criteria be satisfied. For instance, ride identification unit 152 may generate output data indicating that the user rode in a taxi of transit service provider 106A if and only if at least two of the following three criteria are met after the transit service was selected: (1) the user changed from a walking or standing segment to a vehicle riding segment at or near target location 210; (2) the user arrived at or near destination 212; and (3) the user changed from a vehicle riding segment to a walking or standing segment at or near destination 212. In other implementations, ride identification unit 152 may use other suitable factors, algorithms and/or criteria to determine whether the transit service was provided to the user.

In some implementations and/or scenarios where system 100 includes only a single transit service provider 106A (e.g., a train or bus service provider), and the user need not make any selection on mobile communications device 104 prior to using the provider 106A (e.g., prior to boarding the train or bus), the algorithm may rely solely on segmented user activity data, without accounting for any user entry data. Alternatively, in such an implementation/scenario, the algorithm may be based in part on a determination of whether the user selected an option (or launched an application, etc.) that enabled the user to view an ETA for the transit service provider 106A.

Ride identification unit 152 (or another unit) may notify accuracy calculation unit 156 when ride identification unit 152 has determined that a user took a ride from the transit service of transit service provider 106A. Accuracy calculation unit 156 may then determine the difference between the ETA that was originally presented to the user (i.e., the ETA, corresponding to “Best of San Fran Taxi,” that was selected or calculated by ETA selection unit 146) and the time at which the transit service was actually provided to the user at the target location 210 (e.g., the time at which a taxi of transit service provider 106A picked up the user).

To determine the actual pickup time, accuracy calculation unit 156 may access user activity database 160 to determine the time at which the user/device changed from a walking or standing segment to a vehicle riding segment at or near the target location 210. In the example segmented user activity data of FIG. 3, for example, the actual time of pickup is 18 seconds after 2:34 PM. Once the actual pickup time is established, accuracy calculation unit 156 may calculate the difference between the ETA presented to the user at the time the user selected control 220A and the (modified or unmodified) actual arrival time. The ETA that was presented to the user may have been logged in user entry database 162, for example, or another suitable location.

As used herein, a “time difference” between an ETA and an actual arrival time may be the result of a simple subtraction process, or may include one or more modifying factors. In some implementations, for example, accuracy calculation unit 156 subtracts a small amount of time (e.g., 30 seconds, 1 minute, etc.) from the actual pickup time, in order to account for reasonable delays such as maneuvering the taxi into a suitable pickup position/orientation, loading a customer's baggage into a taxi, speaking to the customer about his or her destination, waiting for all passengers to enter before closing train or bus doors, and so on. As another example, accuracy calculation unit 156 may also, or instead, add a small amount of time to the ETA in order to account for the amount of time it takes the user to book a ride after selecting a particular transit service provider via the interactive display 200 of FIG. 2. As will be discussed in further detail below, accuracy calculation unit 156 may also calculate accuracy metrics for transit service providers 106A-106C, based on differences between ETAs and actual pickup times for a number of different users/customers.

### Example Techniques for Determining Accuracy of Arrival Time Information Provided by a Transit Service Provider

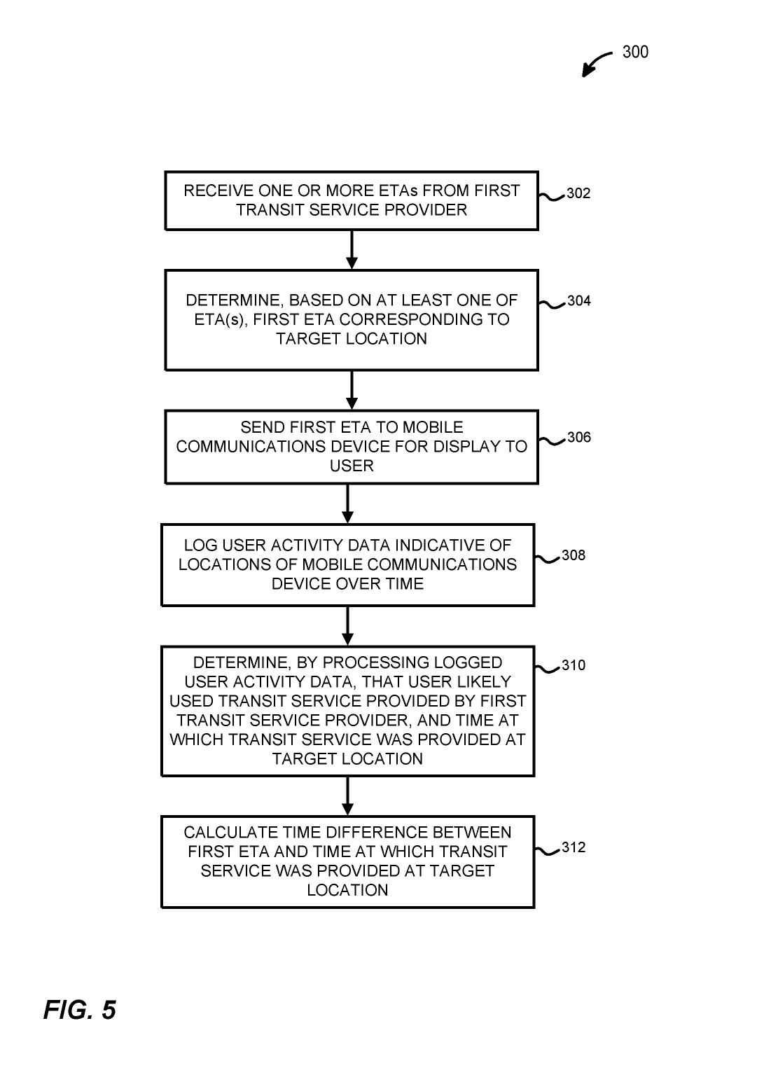

An example method 300 for determining accuracy of arrival time information provided by a transit service provider is discussed next with reference to FIG. 5. The method 300 may be implemented as instructions stored on a computer-readable medium and executed on one or more processors, in one or several computing devices. For example, referring back to FIG. 1, the method 300 may be implemented by map server 102.

At block 302, one or more ETAs are received from a first transit service provider (e.g., transit service provider 106A of FIG. 1, via a network such as network 110). Each of the one or more ETAs indicates a time (e.g., a precise expected time, or a latest expected time, etc.) at which the first transit service provider purports to be able to provide a transit service at a respective location. Each such “location” may be a specific point (e.g., latitude/longitude pair, or a specific stop or station on a pre-defined route), or a larger area. For example, each location may correspond to the area of a respective, pre-defined cell. The ETA(s) may be absolute times (e.g., 2:55 PM) or relative times (e.g., 5 minutes), and may be provided in table format, within a heat map, or in another suitable format. The ETA(s) may be real-time ETAs received via a continuous feed, or in response to a request, for example.

At block 304, a first ETA that corresponds to a target (e.g., pickup) location is determined based on at least one of the ETA(s) received at block 302. The target location may be a current location of a device such as mobile communications device 104 of FIG. 1 (e.g., as determined using GPS or another positioning technology), or may be a starting point specified by a request for directions received from such a device, for example. The first ETA may be selected from among multiple ETAs received at block 302 (e.g., by selecting an ETA corresponding to a location that is nearest the target location), or may be interpolated or otherwise calculated based on two or more of the ETAs received at block 302.

At block 306, the first ETA is sent to the mobile communications device, via a user interface of the mobile communications device (e.g., user interface 124 of FIG. 1), for display to a user of the mobile communications device. In some implementations, the first ETA is sent along with one or more other ETAs corresponding to one or more other transit services (e.g., services of competing transit service providers). Each ETA may be sent along with a name of the transit service corresponding to that ETA, to allow the mobile communications device to display both the names and the ETAs to the user via the user interface of the mobile communications device.

At block 308, user activity data, indicative of locations of the mobile communications device over time, is logged. The user activity data may be logged in a database such as user activity database 160 of FIG. 1, for example. The user activity data may include latitude and longitude coordinates, and/or other suitable location indicators, with time stamps or other information from which the time associated with each location may be determined. In some implementations, user activity data is collected (e.g., received from the mobile communications device) on an continuous or periodic basis while the mobile communications device is powered up, or while a mapping application is executing on the mobile communications device, etc. In other implementations, user activity data is only collected for a short time interval (e.g., starting when the mobile communications device user selects the transit service). In some implementations, the method 300 also includes logging user entry data (e.g., including an indication that the user selected the transit service). The user activity data and/or user entry data may be logged after the user has consented to the collection and use of such data.

At block 310, it is determined, by processing the user activity data logged at block 308, that the mobile communications device user used a transit service provided by the first transit service provider. For example, the determination may be made by determining that the user switched from standing or walking to riding in a vehicle at some point (e.g., within a threshold amount of time) after selecting the transit service. Additionally or alternatively, the determination at block 310 may be made by determining that the user arrived at a destination that was previously indicated by the user (e.g., indicated in a request for directions received from the mobile communications device). Further, the determination may be made by determining that the user switched from riding in a vehicle to standing or walking immediately after arriving at the destination. In some implementations, the determination is also made by processing logged user entry data. For example, the processing at block 310 may, in some implementations, only proceed if it is first determined that the user of the mobile communications device selected an interactive control corresponding to the first transit service provider (e.g., interactive control 220A of FIG. 2).

Also at block 310, the time at which the transit service was provided at the target location (i.e., the “pickup time”) is determined, also by processing the user activity data logged at block 308. The pickup time may be set to the time when the user switched from a walking or standing mode to a vehicle riding mode at or near (e.g., within a threshold distance of) the target location, for example.

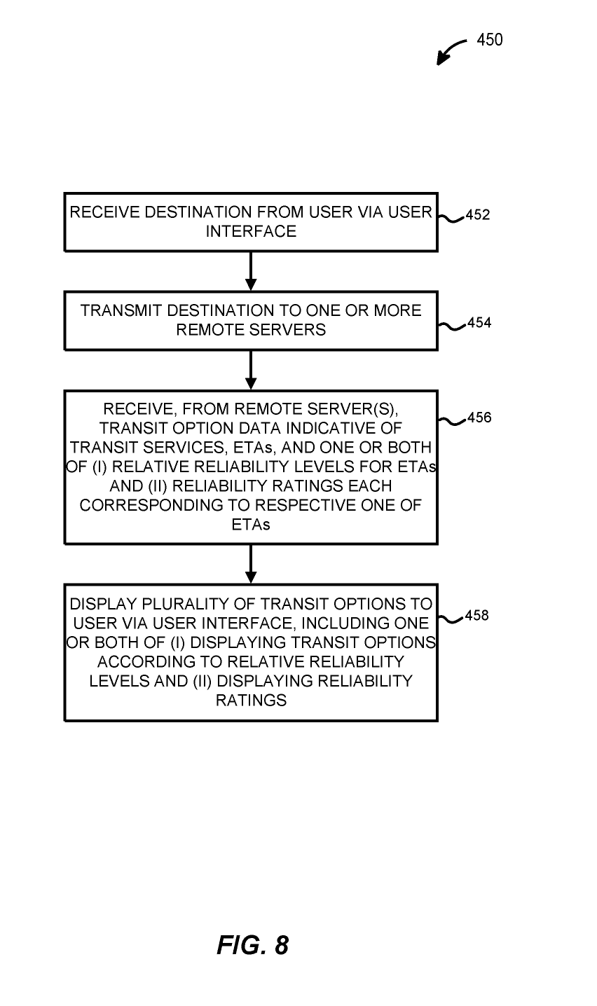

At block 312, a time difference between the first ETA (determined at block 304) and the time at which the transit service was provided at the target location (determined at block 310) is calculated. The time difference may be calculated as a time interval, and/or as a percentage difference ([pickup time−first ETA]/first ETA), for example, and may be used for various different purposes. For example, the method 300 may also include using the time difference, along with other similar comparisons that involve the transit service (but potentially different users/devices), to calculate an accuracy metric indicative of overall accuracy of ETAs provided by the first transit service provider (e.g., only for the transit service that was used, or for the first transit service provider across multiple transit services). The method 300 may further include sending the accuracy metric to the first transit service provider in order to make the first transit service provider aware of its ETA performance (e.g., in an effort to make the first transit service provider increase its ETA accuracy in the future). Alternatively, or in addition, the method 300 may include using the accuracy metric in various ways when providing transit service provider options to users in the future (e.g., as discussed further below in connection with FIG. 8).

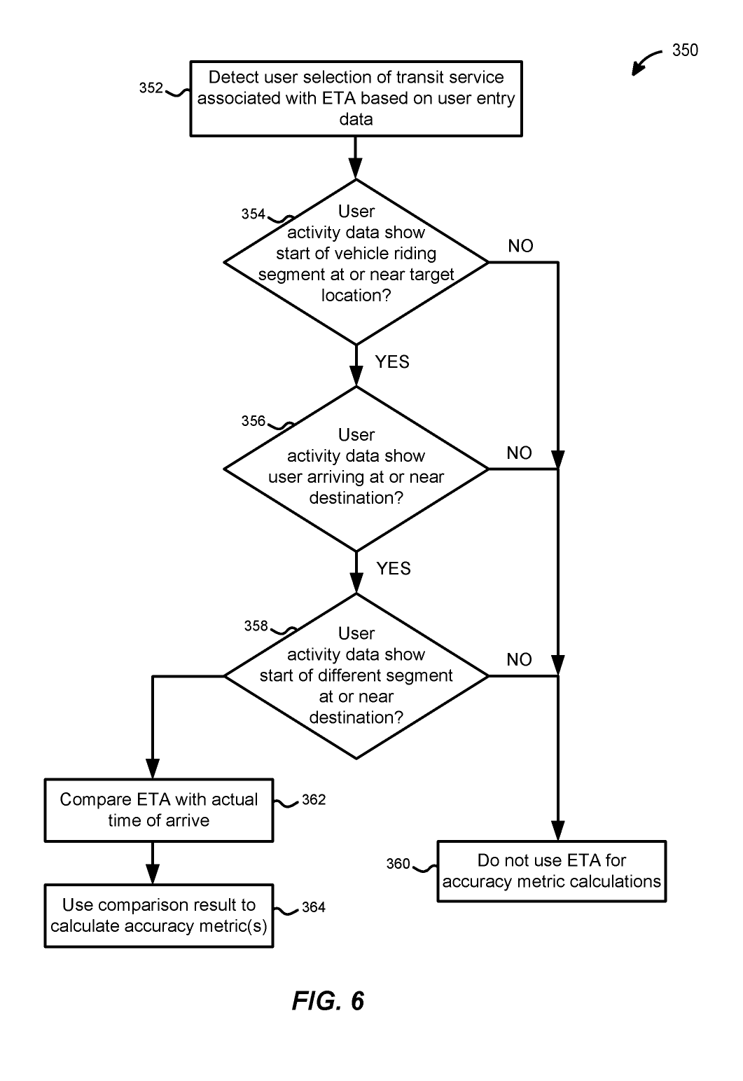

Referring now to FIG. 6, another example method 350 for determining accuracy of arrival time information provided by a transit service provider is illustrated. The method 350 may correspond to a more specific implementation of at least a portion of the method 300 as shown in FIG. 5, for example. As with the method 300, the method 350 may be implemented as instructions stored on a computer-readable medium and executed on one or more processors, in one or several computing devices (e.g., in map server 102 of FIG. 1).

At block 352, a user selection of a transit service (e.g., a service offered by transit service provider 106A of FIG. 1) is detected based on user entry data (e.g., a user “click” or other selection of the transit service, via a user interface such as user interface 124 of FIG. 1). The selected transit service is associated with an ETA that was initially provided by (or calculated based on one or more ETAs initially provided by) the transit service provider, and may have been presented to the user prior to the user's selection.

At blocks 354, 356 and 358, user activity data is processed to determine whether or not the user ended up using the selected transit service. The determinations at blocks 354, 358, and possibly 356 may be made in part by segmenting the user activity data in a manner similar to that shown in FIG. 3, for example. At block 354, it is determined whether user activity data (e.g., location/time data for the user's mobile communications device) shows the start of a riding (e.g., vehicle riding) segment at or near a target location. As discussed above, the target location may be a location of the user's mobile communications device at a time when real-time ETAs for different transit services were presented to the user, or may be a starting point specified in a request for directions entered by the user, etc. If it is determined that no vehicle riding segment begins at or near the target location (e.g., within some pre-determined or calculated time limit), flow may proceed to block 360. Otherwise, flow may proceed to block 356.

At block 356, it is determined whether the user activity data shows the user arriving at or near the user's destination (e.g., a destination specified in a request for directions entered by the user). If it is determined that the user did not arrive at or near the destination (e.g., within some pre-determined or calculated time limit), flow may proceed to block 360. Otherwise, flow may proceed to block 358.

At block 358, it is determined whether the user activity data shows the start of a different, non-riding (e.g., walking or standing) segment at or near the destination. If it is determined that the user did not change to a non-riding segment at or near the destination (e.g., within some pre-determined or calculated time limit), flow may proceed to block 360. Otherwise, flow may proceed to block 362.

It is noted that at least blocks 354, 356 and/or 358 may occur in a different order than that shown in FIG. 6. Moreover, the method 350 may include additional blocks for determining that a user made use of the transit service of the provider, or may include fewer blocks. For example, block 356 and/or block 358 may be omitted.

At block 360, a decision is made to not use the ETA associated with the transit service when calculating an accuracy metric for the transit service or transit service provider (i.e., a composite metric representing the accuracy of multiple ETAs provided by the transit service provider for the transit service over time and/or over a number of different users). In other implementations, the algorithm for determining whether to use the ETA in the accuracy metric calculation may be different than (e.g., far more complex than) that shown in FIG. 6.

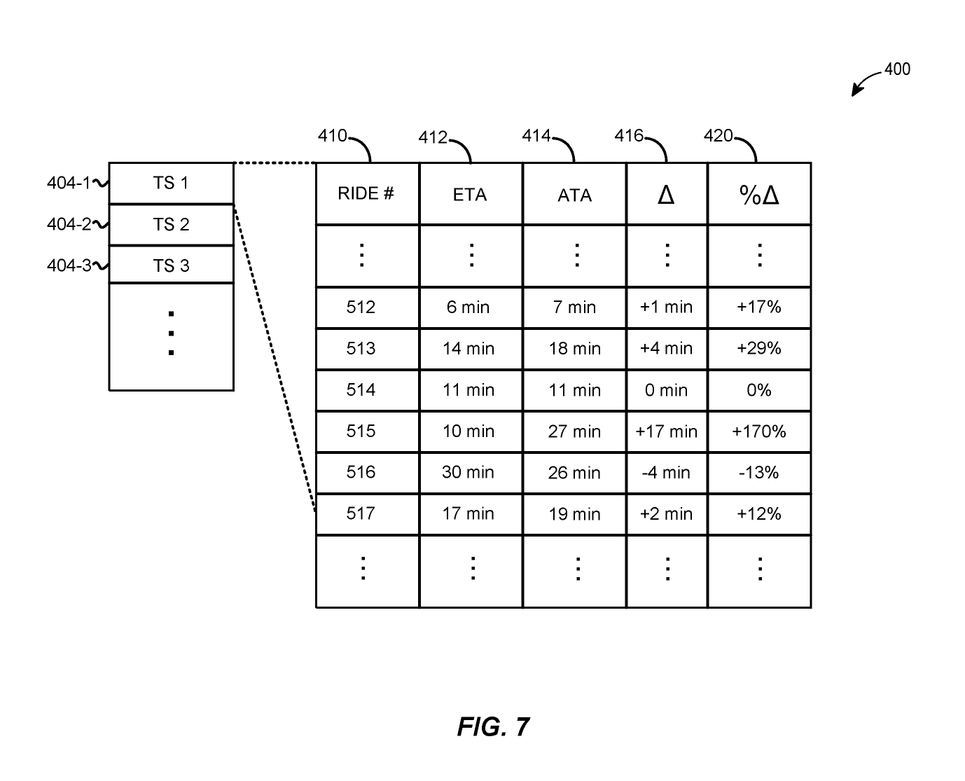

At block 362, the ETA associated with the transit service is compared to the actual time of arrival. The actual arrival time may be determined based on the user activity data. For example, the actual arrival time may be the time of the start of the vehicle riding segment identified at block 354. The comparison may be used to generate a result comprising one or more outputs, such as a time difference (e.g., 5 minutes), a percentage time difference, and so on. At block 364, the comparison result is used to calculate one or more accuracy metrics for the transit service or transit service provider, which may be used in any of the ways described elsewhere herein (e.g., provided to the transit service provider, used when presenting future transit service options to a user, etc.). Some example accuracy metrics are discussed below in connection with FIG. 7, and some example uses of such metrics are discussed below in connection with FIG. 8.

### Example Techniques for Determining Overall ETA Accuracy Metrics

FIG. 7 depicts an example collection 400 of ETA accuracy data that may be used to calculate accuracy metrics for a number of different transit services. The data collection 400 may represent data output by accuracy calculation unit 156 and stored in memory 142, for example. The example data collection 400 includes a number of transit service records 404 each corresponding to a different transit service. While many other arrangements and/or types of data may be used, the example data collection 400 includes, for each transit service, a number of ride identifiers 410, a number of ETAs 412, a number of actual times of arrival (ATAs) 414, a number of time differences 416, and a number of percentage time differences 420. In various different implementations and/or scenarios, each of the transit services corresponding to transit service records 404 may be offered by a different transit service provider, or some or all of the transit services may be offered by a single transit service provider.

Ride identifiers 410 correspond to different rides that were given to users of mobile communications devices, as determined with some degree of confidence by processing user activity and/or user entry data (e.g., using any of the techniques described above). Each of ride identifiers 410 may correspond to one instance in which ride identification unit 152 of FIG. 1 determined that a user made use of a transit service associated with transit service record 404-1, for example.

Each of ETAs 412 may be a real-time ETA that was provided by the transit service provider just prior to the corresponding ride, or an ETA calculated based on one or more ETAs provided by the transit service provider (e.g., using interpolation), for example. Each of ATAs 414 may be the actual arrival/pickup times as determined by processing user activity data (e.g., as determined by ride identification unit 152 and/or activity segmentation unit 154 of FIG. 1). While the ETAs 412 and ATAs 414 are shown in units of minutes, other levels of precision (e.g., seconds) are possible for ETAs 412 and/or ATAs 414, and/or different measures of time may be used (e.g., absolute/clock times rather than relative times).

Each of the time differences 416 is a difference between the respective ETA of ETAs 412 and the respective ATA of ATAs 414, with a positive sign representing a delay and a negative sign representing an early pickup. As noted above, in some implementations, the time differences 416 may take certain other factors/offsets into account. Each of percentage time differences 420 is calculated according to the formula Δ/ETA.

All of the time differences 416 and/or percentage time differences 420 in transit service record 404-1, or a subset thereof (e.g., corresponding to all rides within the last day, week or month, etc.) may be used to calculate one or more accuracy metrics for the transit service associated with record 404-1. For example, the accuracy metric(s) may include an average delay (in minutes), an average percentage delay, a standard deviation of delay and/or of percentage delay, a maximum delay and/or maximum percentage delay, and so on. In some implementations where more than one of the transit services are offered by a single transit service provider, accuracy metrics may also, or instead, by calculated for each provider (e.g., by averaging the accuracy metrics for all transit services of a single provider, or using the worst-case accuracy metric, etc.).

Moreover, each of transit service records 404 may divide ride identifiers 410, ETAs 412, ATAs 414, time differences 416, and percentage time differences 420 into subsets corresponding to different geographic areas, with accuracy metrics being calculated separately for each subset. Thus, for example, a first accuracy metric may be calculated for a transit service in a first geographic area (e.g., New York City), and a second accuracy metric may be calculated for the same transit service in a second geographic area (e.g., San Francisco).

### Example Uses of ETA Accuracy Metrics

ETA accuracy metrics, such as those generated using the time differences 416 and/or percentage time differences 420 of FIG. 7, may be used in different ways in various implementations and/or scenarios. For example, the accuracy metrics may be sent to the appropriate transit service providers (e.g., taxi, ride-sharing, bus and/or train providers) to facilitate better compliance with accuracy standards of a company associated with map server 102 of FIG. 1, and/or accuracy standards of the transit service providers. In one implementation, map server 102 may transmit the accuracy metrics to one or more of transit service providers 106A-106C via network 110. In some implementations where different accuracy metrics are calculated for different geographic regions, transit service providers may review the received accuracy metrics to compare ETA accuracy across different regions. In some implementations where different accuracy metrics are calculated for different transit services of a single provider, transit service providers may review the received accuracy metrics to compare ETA accuracy across different services. In some implementations where a transit service provider is a government agency or third party contractor, the accuracy metrics may be used to analyze or verify delays of buses, trains, etc., as reported by the agency or third party contractor. The metrics may be used to determine whether delays are within acceptable limits (e.g., as specified by state laws or regulations, such as a requirement that at least 95% of departures be within 5 minutes of the scheduled time), for example.

As another example, the accuracy metrics may be used to determine which transit services to include as options when presenting providers/ETAs to users within a mapping application. For instance, only transit services having an accuracy metric above some threshold level may be included in the options presented to users, and/or one or more other qualifying criteria may be used. Moreover, non-mapping applications may make use of the accuracy metrics. For example, a search engine application, intelligent personal assistant application, or other application may only provide results corresponding to transit services having an accuracy metric above a threshold level.

As yet another example, the accuracy metrics may be used to rank and/or rate the transit services. Future transit service options may then be presented to users in accordance with those rankings and/or ratings, in order to offer users/customers some indicia of reliability. FIG. 8 is a flow diagram of an example method 450 for displaying arrival time information with indicia of ETA reliability. The method 450 may be implemented as instructions stored on a computer-readable medium and executed on one or more processors in a mobile communications device also having a user interface and a network interface (e.g., a device similar to mobile communications device 104 of FIG. 1).

At block 452, a destination is received from a user via the user interface. The destination may be one that the user typed in when requesting directions via a mapping application (e.g., mapping application 130 of FIG. 1), for example. Other information may also be received, such as a starting location entered by the user. At block 454, the destination is transmitted to one or more remote servers (e.g., to map server 102 of FIG. 1) via the network interface. Other information may also be transmitted to the remote server(s) at block 454, such as a starting location entered by the user or a current location of the user (as determined by GPS, WiFi positioning technology, etc.).

At block 456, transit option data is received from the remote server(s) via the network interface. The transit option data is indicative of a plurality of transit services, and indicative of a plurality of ETAs each corresponding to a target/pickup location and a respective one of the plurality of transit services. If the mobile communications device sent a starting location to the remote server(s) at block 454, the target location may be that starting location. If no starting location was sent, but the remote server(s) were already aware of the current location of the mobile communications device, the target location may be that current location.

The transit option data also includes information indicative of reliability of the ETAs associated with each of the transit services. In one implementation, for example, the transit option data includes data indicative of relative reliability levels for the plurality of ETAs. For instance, the transit option data may indicate an order in which the transit services and their respective ETAs should be presented to the user on the user interface, with lower positions/rankings corresponding to poorer accuracy metrics. Additionally or alternatively, the transit option data may include data indicative of reliability ratings for each of the ETAs (e.g., “high,” “low,” a number or letter rating, color-coding of provider names, etc.).

At block 458, transit options are displayed to the user via the user interface. Each of the transit options corresponds to a different one of the transit services indicated by the transit option data, and includes a respective one of the ETAs indicated by the transit option data. The transit options may be displayed to the user according to the reliability information in the transit option data. If the transit option data was indicative of relative reliability levels (e.g., by specifying an ordered sequence reflecting relative rankings of the transit services), the transit options may be displayed according to those levels (e.g., in the specified order). If the transit option data was indicative of reliability ratings (e.g., by including a text-based or other rating for each ETA/provider), the transit options may be displayed along with those ratings.

While not shown in FIG. 8, the method 450 may also include additional blocks. For example, the method 450 may include additional blocks that allow other accuracy metrics to be generated, and/or allow existing accuracy metrics to be updated. For instance, the method 450 may include, after block 458, blocks in which a selection of a first transit option is received via the user interface, user activity data is transmitted to the remote server(s), and user entry data is transmitted to the remote server(s).

### Example Aspects of the Invention

Although the foregoing text sets forth a detailed description of numerous different aspects and embodiments of the invention, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. By way of example, and not limitation, the disclosure herein contemplates at least the following aspects:

Aspect 1—A method, implemented in one or more servers, for determining accuracy of arrival time information provided by a first transit service provider, the method comprising: (1) receiving, from the first transit service provider, one or more ETAs, each of the one or more ETAs indicating a time at which the first transit service provider purports to be able to provide a transit service at a respective location; (2) determining, by one or more processors of the one or more servers and based on at least one of the one or more ETAs, a first ETA corresponding to a target location; (3) sending the first ETA to the mobile communications device for display to a user via a user interface of the mobile communications device; (4) logging, by the one or more processors, user activity data indicative of locations of the mobile communications device over time; (5) determining, by the one or more processors processing the logged user activity data, (i) that the user used the transit service provided by the first transit service provider, and (ii) a time at which the transit service was provided at the target location; and (6) calculating, by the one or more processors, a time difference between the first ETA and the time at which the transit service was provided at the target location.

Aspect 2—The method of aspect 1, further comprising: receiving a request for directions from the mobile communications device, the request for directions including a starting point and a destination, wherein determining a first ETA corresponding to a target location includes determining a first ETA corresponding to the starting point.

Aspect 3—The method of aspect 1, wherein determining a first ETA corresponding to a target location includes determining a first ETA corresponding to a current location of the mobile communications device.

Aspect 4—The method of any one of aspects 1-3, further comprising: logging user entry data indicative of one or more inputs made by the user via the user interface, wherein determining that the user used the transit service provided by the first transit service provider is performed by the one or more processors processing the logged user activity data and the logged user entry data.

Aspect 5—The method of aspect 4, wherein determining that the user used the transit service provided by the first transit service provider further includes: determining, by the one or more processors processing the logged user entry data, that the user selected the transit service via the user interface.

Aspect 6—The method of aspect 5, wherein determining that the user used the transit service provided by the first transit service provider further includes: determining, by the one or more processors processing the logged user activity data, that the user switched from standing or walking to riding in a vehicle after selecting the transit service.

Aspect 7—The method of any one of aspects 1 or 3-6, further comprising: receiving a request for directions from the mobile communications device, the request for directions including a starting point and a destination, wherein determining that the user used the transit service provided by the first transit service provider further includes determining, by the one or more processors processing the logged user activity data, that the user arrived at the destination.

Aspect 8—The method of aspect 7, wherein determining that the user used the transit service provided by the first transit service provider further includes: determining, by the one or more processors processing the logged user activity data, that the user switched from riding in a vehicle to standing or walking after arriving at the destination.

Aspect 9—The method of any one of aspects 1-8, wherein sending the first ETA to the mobile communications device includes: (1) sending a plurality of ETAs to the mobile communications device for display to the user via the user interface, each of the plurality of ETAs corresponding to a different one of a plurality of transit services, the plurality of ETAs including the first ETA; and (2) sending names of the plurality of transit services to the mobile communications device for display to the user via the user interface, each of the names being associated with a respective one of the plurality ETAs.

Aspect 10—The method of any one of aspects 1-9, further comprising: calculating, by the one or more processors and using (i) the calculated time difference and (ii) a plurality of additional time differences each corresponding to a respective ETA provided by the first transit service provider, an accuracy metric indicative of overall accuracy of ETAs provided for the transit service by the first transit service provider.

Aspect 11—The method of aspect 10, further comprising: sending the accuracy metric to the first transit service provider.

Aspect 12—The method of aspect 10 or 11, further comprising: (1) assigning, by the one or more processors processing the accuracy metric, a rating (e.g., the accuracy metric, or a rating derived therefrom) to the transit service or the first transit service provider; and (2) one or both of (A) causing another mobile communications device to display a name of the transit service at a position within a list of different transit services, the position within the list being based on the assigned rating, and (B) causing the other mobile communications device to display the name of the transit service along with an indicator of reliability, the indicator of reliability being either (i) the assigned rating or (ii) an indicator selected by the one or more processors based on the assigned rating.

Aspect 13—The method of any one of aspects 1-12, wherein the transit service is one of (i) a taxi service, (ii) a ride-sharing service, (iii) a train service, or (iv) a bus service.

Aspect 14—The method of any one of aspects 1-13, wherein: (1) receiving the one or more ETAs includes receiving a plurality of ETAs via a real-time feed from the first transit service provider; and (2) determining a first ETA corresponding to a target location includes either (i) selecting one of the plurality of ETAs as the first ETA, or (ii) calculating the first ETA by interpolating between two or more of the plurality of ETAs.

Aspect 15—A system for determining accuracy of arrival time information, the system comprising: (1) a network interface; (2) one or more databases collectively storing (i) user activity data indicative of locations of mobile communications devices over time and (ii) user entry data indicative of inputs made by users via user interfaces of the mobile communications devices; and (3) one or more servers collectively configured to (A) receive, from a first transit service provider via the network interface, one or more ETAs, each of the one or more ETAs indicating a time at which the first transit service provider purports to be able to provide a transit service at a respective location, (B) determine, based on at least one of the one or more ETAs, a first ETA corresponding to a target location, (C) send, via the network interface, the first ETA to the first mobile communications device for display to a first user via a user interface of the first mobile communications device, (D) log, in the one or more databases, (i) first user activity data indicative of locations of the first mobile communications device over time and (ii) first user entry data indicative of inputs made by the first user via the user interface of the first mobile communications device, (E) determine, by processing the logged first user activity data and the logged first user entry data, that the user used the transit service provided by the first transit service provider, (F) determine, by processing the logged first user activity data, a time at which the transit service was provided at the target location, and (G) calculate a time difference between the first ETA and the time at which the transit service was provided at the target location.

Aspect 16—The system of aspect 15, wherein the one or more servers are further collectively configured to, before determining the first ETA, receive a request for directions from the first mobile communications device, the request for directions including a starting point and a destination, and wherein determining that the first user used the transit service provided by the first transit service provider includes: (1) determining, by processing the logged first user entry data, that the first user selected the transit service via the user interface of the first mobile communications device; and (2) determining, by processing the logged first user activity data, (i) that the first user switched from standing or walking to riding in a vehicle after selecting the transit service, and (ii) that the first user arrived at the destination.

Aspect 17—The system of aspect 15 or 16, wherein the one or more servers are further collectively configured to: (1) calculate, using (i) the calculated time difference and (ii) a plurality of additional time differences each corresponding to a respective ETA provided by the first transit service provider, an accuracy metric indicative of overall accuracy of ETAs provided for the transit service by the first transit service provider; and (2) one or both of (i) send the accuracy metric to the first transit service provider, and (ii) assign, based on the accuracy metric, a rating (e.g., the accuracy metric, or a rating derived therefrom) to the first transit service provider or the transit service, and cause another mobile communications device to display a name of the transit service at a position within an ordered sequence of different transit services, the position within the ordered sequence being based on the assigned rating.

Aspect 18—A method, implemented in a mobile communications device having a user interface, a network interface and one or more processors, for displaying arrival time information with indicia of ETA reliability, the method comprising: (1) receiving a destination from a user via the user interface; (2) transmitting the destination to one or more remote servers via the network interface; (3) receiving from the one or more remote servers, via the network interface, transit option data indicative of (i) a plurality of transit services, and (ii) a plurality of ETAs each corresponding to a target location and a respective one of the plurality of transit services; and (4) displaying a plurality of transit options to the user via the user interface, each of the plurality of transit options corresponding to a respective one of the plurality of transit services and including the respective one of the plurality of ETAs, wherein one or both of: (i) the transit option data is further indicative of relative reliability levels for the plurality of ETAs, and displaying the plurality of transit options includes displaying the plurality of transit options according to the relative reliability levels, and (ii) the transit option data is further indicative of a plurality of reliability ratings each corresponding to a respective one of the plurality of ETAs, and displaying the plurality of transit options further includes displaying the plurality of reliability ratings.

Aspect 19—The method of aspect 18, wherein the transit option data is indicative of the relative reliability levels for the plurality of ETAs, and displaying the plurality of transit options includes displaying the plurality of transit options in an ordered sequence according to the relative reliability levels.

Aspect 20—The method of aspect 18 or 19, further comprising: (1) receiving from the user, via the user interface, a selection of a first transit option from among the plurality of transit options, the first transit option corresponding to a first transit service and a first ETA; (2) transmitting user activity data to the one or more remote servers via the network interface, the user activity data indicative of locations of the mobile communications device over time; and (3) transmitting user entry data to the one or more remote servers via the network interface, the user entry data including data indicative of the selection of the first transit option.

### Other Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments (“embodiments” and “implementations” being used interchangeably herein) are described in the present disclosure as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described in the present disclosure.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described in the present disclosure. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described in the present disclosure may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to in the present disclosure may, in some example embodiments, comprise processor-implemented modules.

Similarly, the methods or routines described in the present disclosure may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, at least some of the operations may be performed by a group of computers (as examples of machines including processors), these operations being accessible via a network (e.g., the Internet) and via one or more appropriate interfaces (e.g., application program interfaces (APIs).)

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used in the present disclosure, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments in the present disclosure. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for determining accuracy of ETAs in real-time feeds through the disclosed principles in the present disclosure. Thus, while particular embodiments and applications have been illustrated and described, it is to be understood that the disclosed embodiments are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

1. A method, implemented in one or more servers, for determining accuracy of arrival time information provided by a first transit service provider, the method comprising:
receiving, from the first transit service provider, one or more estimated times of arrival (ETAs), each of the one or more ETAs indicating a time at which the first transit service provider purports to be able to provide a transit service at a respective location;
determining, by one or more processors of the one or more servers and based on at least one of the one or more ETAs, a first ETA corresponding to a target location;
sending the first ETA to a mobile communications device for display to a user via a user interface of the mobile communications device;
logging, by the one or more processors, (i) user activity data indicative of locations of the mobile communications device over time and (ii) user entry data indicative of one or more inputs made by the user via the user interface;
after logging the user activity data and the user entry data, determining, by the one or more processors batch processing the logged user activity data and the logged user entry data, (i) that the user used the transit service provided by the first transit service provider, and (ii) a time at which the transit service was provided at the target location, wherein determining that the user used the transit service provided by the first transit service provider includes determining, based on the logged user entry data, that the user selected the transit service by activating, on a display of the mobile communications device, an interactive control associated with the transit service; and
calculating, by the one or more processors, a time difference between the first ETA and the time at which the transit service was provided at the target location.

2. The method of claim 1, further comprising:
receiving a request for directions from the mobile communications device, the request for directions including a starting point and a destination,
wherein determining a first ETA corresponding to a target location includes determining a first ETA corresponding to the starting point.

3. The method of claim 1, wherein determining a first ETA corresponding to a target location includes determining a first ETA corresponding to a current location of the mobile communications device.

4-5. (canceled)

6. The method of claim 1, wherein determining that the user used the transit service provided by the first transit service provider further includes:
determining, by the one or more processors processing the logged user activity data, that the user switched from standing or walking to riding in a vehicle after selecting the transit service.

7. The method of claim 6, further comprising:
receiving a request for directions from the mobile communications device, the request for directions including a starting point and a destination,
wherein determining that the user used the transit service provided by the first transit service provider further includes determining, by the one or more processors processing the logged user activity data, that the user arrived at the destination.

8. The method of claim 7, wherein determining that the user used the transit service provided by the first transit service provider further includes:
determining, by the one or more processors processing the logged user activity data, that the user switched from riding in a vehicle to standing or walking after arriving at the destination.

9. The method of claim 1, wherein sending the first ETA to the mobile communications device includes:
sending a plurality of ETAs to the mobile communications device for display to the user via the user interface, each of the plurality of ETAs corresponding to a different one of a plurality of transit services, the plurality of ETAs including the first ETA; and
sending names of the plurality of transit services to the mobile communications device for display to the user via the user interface, each of the names being associated with a respective one of the plurality ETAs.

10. The method of claim 1, further comprising:
calculating, by the one or more processors and using (i) the calculated time difference and (ii) a plurality of additional time differences each corresponding to a respective ETA provided by the first transit service provider, an accuracy metric indicative of overall accuracy of ETAs provided for the transit service by the first transit service provider.

11. The method of claim 10, further comprising:
sending the accuracy metric to the first transit service provider.

12. The method of claim 10, further comprising:
assigning, by the one or more processors processing the accuracy metric, a rating to the transit service or the first transit service provider; and
one or both of
causing another mobile communications device to display a name of the transit service at a position within a list of different transit services, the position within the list being based on the assigned rating, and
causing the other mobile communications device to display the name of the transit service along with an indicator of reliability, the indicator of reliability being either (i) the assigned rating or (ii) an indicator selected by the one or more processors based on the assigned rating.

13. The method of claim 1, wherein the transit service is one of (i) a taxi service, (ii) a ride-sharing service, (iii) a train service, or (iv) a bus service.

14. The method of claim 1, wherein:
receiving the one or more ETAs includes receiving a plurality of ETAs via a real-time feed from the first transit service provider; and
determining a first ETA corresponding to a target location includes either (i) selecting one of the plurality of ETAs as the first ETA, or (ii) calculating the first ETA by interpolating between two or more of the plurality of ETAs.

15. A system for determining accuracy of arrival time information, the system comprising:
a network interface;
one or more databases collectively storing (i) user activity data indicative of locations of mobile communications devices over time and (ii) user entry data indicative of inputs made by users via user interfaces of the mobile communications devices; and
one or more servers collectively configured to
receive, from a first transit service provider via the network interface, one or more estimated times of arrival (ETAs), each of the one or more ETAs indicating a time at which the first transit service provider purports to be able to provide a transit service at a respective location,
determine, based on at least one of the one or more ETAs, a first ETA corresponding to a target location,
send, via the network interface, the first ETA to a first mobile communications device for display to a first user via a user interface of the first mobile communications device,
log, in the one or more databases, (i) first user activity data indicative of locations of the first mobile communications device over time and (ii) first user entry data indicative of inputs made by the first user via the user interface of the first mobile communications device,
after logging the first user activity data and the first user entry data, (i) determine, by batch processing the logged first user activity data and the logged first user entry data, that the user used the transit service provided by the first transit service provider, at least in part by determining, based on the logged first user entry data, that the first user selected the transit service by activating, on a display of the first mobile communications device, an interactive control associated with the transit service, and (ii) determine, by batch processing the logged first user activity data, a time at which the transit service was provided at the target location, and
calculate a time difference between the first ETA and the time at which the transit service was provided at the target location.

16. The system of claim 15, wherein the one or more servers are further collectively configured to, before determining the first ETA, receive a request for directions from the first mobile communications device, the request for directions including a starting point and a destination, and wherein determining that the first user used the transit service provided by the first transit service provider includes:
determining, by batch processing the logged first user activity data, (i) that the first user switched from standing or walking to riding in a vehicle after selecting the transit service, and (ii) that the first user arrived at the destination.

17. The system of claim 15, wherein the one or more servers are further collectively configured to:
calculate, using (i) the calculated time difference and (ii) a plurality of additional time differences each corresponding to a respective ETA provided by the first transit service provider, an accuracy metric indicative of overall accuracy of ETAs provided for the transit service by the first transit service provider; and
one or both of
(i) send the accuracy metric to the first transit service provider, and
(ii) assign, based on the accuracy metric, a rating to the first transit service provider or the transit service, and cause another mobile communications device to display a name of the transit service at a position within an ordered sequence of different transit services, the position within the ordered sequence being based on the assigned rating.

18-20. (canceled)
